(19) United States
(12) Patent Application Publication
(10) Pub. No.: US 2026/0297782 A1
(43) Pub. Date: Oct. 1, 2026

(54) PROCESS AND SYSTEM FOR ELECTROLYTICALLY PRODUCING AN IRON-BEARING PRODUCT FROM IRON ORE PARTICLES

(71) Applicant: Fortescue Future Industries Pty Ltd, East Perth (AU)

(72) Inventors: Soheila Mohammadzadehmoghadam, West Perth (AU); Qiwen Lai, Wembley (AU); Colin Suk Mo Kang, Joondalup (AU); Miles Page, Claremont (AU)

(73) Assignee: Fortescue Future Industries Pty Ltd, East Perth (AU)

(21) Appl. No.: 19/490,850

(22) PCT Filed: Jun. 7, 2023
(86) PCT No.: PCT/AU2023/050500

§ 371 Date: Dec. 5, 2025

(51) Int. Cl. C25C 1/06; C25C 7/02; C25C 7/04; C25C 7/08; C25D 3/20

(52) U.S. Cl. CPC C25C 1/06; C25C 7/04; C25C 7/08; C25C 7/02; C25D 3/20

(57) ABSTRACT

A continuous process for electrolytically producing solid particles of an iron-bearing product from iron ore particles is disclosed. The process is performed in an electrochemical flow reactor provided with an electrochemical cell comprising a cathodic compartment and an anodic compartment separated by a separator, wherein the cathodic compartment houses a cathode and the anodic compartment houses an anode at least partially in contact with an anolyte. A catholyte comprising iron ore particles having a particle size P80 greater than 20 μm suspended in an alkaline electrolyte is circulated through the cathodic compartment and an electrical potential greater than 1.4V is applied between the cathode and the anode in the electrochemical cell and electrolytically reduce the iron ore particles to solid particles of the iron-bearing product suspended in the alkaline electrolyte (spent catholyte). The spent catholyte is then circulated to a separation means whereby the iron-bearing product particles are separated from the spent catholyte resulting in a depleted catholyte. Iron ore particles may then be introduced into the depleted catholyte and the resulting replenished catholyte is recirculated to the cathodic chamber.

### TECHNICAL FIELD

The present disclosure relates to a process and system for electrolytically producing an iron-bearing product from iron ore particles, in particular a continuous process for electrolytically producing an iron-bearing product from iron ore particles.

### BACKGROUND

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Metallic iron is conventionally produced via a carbothermal reduction route, i.e. CO₂ intensive reduction of iron oxides, in a blast furnace at a temperatures of up to ~2000° C. This process produces a large amount of CO₂ emission (i.e. 1.5 metric tons of CO₂ per metric ton of crude Fe produced, as reported in by IEA (2022) Achieving Net Zero Heavy Industry Sectors in G7 Members, IEA, Paris)). Gaseous reduction of iron oxide ore with hydrogen and natural gas is an environmental approach to produce metal iron with reduced carbon emission. However, the cost of hydrogen is relatively expensive for iron production.

More recently, the ultra-low CO₂ steelmaking (ULCOS) program was undertaken by the European Commission to develop electrochemical techniques to reduce greenhouse gases emissions in iron production. Although electrolytic production of aluminium is well-established, it is challenging to apply analogous process techniques to iron production because iron oxides have high melting temperatures. Molten oxide electrolysis (MOE) is the most studied electrometallurgical technique for the production of liquid iron from iron oxides, according to reaction (1).

4Fe³⁺+6O²⁻→4Fe(I)+3O₂(g) (1)

Reaction (1) requires high temperature (i.e. ~1538° C.) to maintain the metallic iron products in liquid phase. Haarberg and co-workers (G. M. Haarberg 2007) reduced iron oxide directly to iron in molten CaCl₂—CaF₂ at 827-890° C., while Li and co-workers (Guoming Li 2009) reported direct electrochemical reduction in molten CaCl₂ at 800-900° C. Additionally, it is difficult to select an inert anode that is effective at high temperature and not subject to oxidation under these reaction conditions.

Low temperature processes for the electroreduction of iron oxide to metallic iron has also been reported. Generally, these processes involve electrowinning (i.e. electrodeposition) of metallic iron on a stationary, rotating or colloidal cathode from an alkaline solution. The metallic iron may be recovered by removing the cathode from the electrolytic cell and scraping the metallic iron from the surface of the cathode. Thus, the recovery of the metallic iron requires either disassembly of the electrochemical cell or at least removal of the cathode to recover the iron that is deposited thereon. Such processes can only enable batch mode processing and are not suitable for a continuous production of metallic iron from large volumes of iron ore.

Various embodiments of the process disclosed herein seek to overcome or improve at least some of the above mentioned disadvantages.

### SUMMARY

The present disclosure provides a process and system for electrolytically producing solid particles of an iron-bearing product from iron ore particles, in particular a continuous process for electrolytically producing solid particles of an iron-bearing product from iron ore particles.

In a first aspect there is provided a continuous process for electrolytically producing solid particles of an iron-bearing product from iron ore particles, the process comprising:
providing an electrochemical flow reactor provided with an electrochemical cell comprising a cathodic compartment and an anodic compartment separated by a separator, wherein the cathodic compartment houses a cathode at least partially in contact with an alkaline catholyte comprising iron ore particles having a particle size P80 of greater than 20 μm suspended therein, and the anodic compartment houses an anode at least partially in contact with an alkaline anolyte;
circulating the alkaline catholyte comprising said iron ore particles through the cathodic compartment;
applying an electrical potential greater than 1.4V between the cathode and the anode in the electrochemical cell to electrolytically reduce the iron ore particles to solid particles of the iron-bearing product suspended in the catholyte thereby producing a spent catholyte;
circulating the spent catholyte to a separation means and separating the iron-bearing product particles from the spent catholyte to produce a depleted catholyte; and
introducing said iron ore particles into the depleted catholyte to produce a replenished catholyte and recirculating the replenished catholyte to the cathodic compartment.

Generally, for the purposes of electrolytic reduction of metals, the electrical potential applied to an electrochemical cell is selected to minimise competing side reactions such as the production of hydrogen gas at the cathode because it reduces the Faradaic efficiency of the electrochemical cell. Furthermore, generation of hydrogen gas bubbles at the surface of the cathode is commonly regarded as detrimental to electrodeposition of the metal on the cathode surface.

Counterintuitively, the inventors have realised that it is advantageous in the subject process to apply an electrical potential that favours the competing side reaction of hydrogen gas production at the cathode as well as reduction of the iron ore particles to the iron-bearing product, even though it results in reduced Faradaic efficiency. Generation of hydrogen gas bubbles at the surface of the cathode limits electrodeposition of iron metal on the cathode. Although an amount of metallic iron may still be deposited on the cathode, the inventors have found that the solid iron ore particles undergo electrolysis to produce solid iron-bearing product particles. The solid iron-bearing product particles may be readily separated from the spent catholyte without needing to disassemble the electrochemical flow reactor to remove the cathode, as would normally be the case when iron is electrodeposited on the cathode. Furthermore, after the solid iron-bearing product particles have been separated from the spent catholyte to produce a depleted catholyte, the depleted catholyte may be replenished with iron ore particles to enable continuous processing. In this way, the process and system as described herein provides for continuous production and separation of solid particles of an iron-bearing product by electrolysis of a suspension of iron ore particles in an alkaline solution.

Advantageously, the inventors have also discovered that the process as disclosed herein is suitable for iron ore particle sizes having a P80 greater than 20 μm, in particular iron ore particle sizes having a P80 greater than 75 μm. Particles having a P80 greater than 75 μm may be produced by a single grinding process whereas particles having a smaller P80 may need to undergo two or more grinding processes, thereby increasing the capital and operational costs of treating large volumes of iron ore. According to the World Steel Association, 1.878 billion tonnes of steel was globally made in 2022 (see https://worldsteel.org/media-centre/press-releases/2023/december-2022-crude-steel-production-and-2022-global-totals). As large quantities of iron are needed to make steel at such a scale, it can be readily appreciated that by not having to grind the iron ore to smaller particle sizes the processes described herein could result in significant cost savings. The subject process may be conveniently deployed with iron ore particles having a P80 greater than 75 μm.

The reduction of the iron ore particles in the processes as described herein is a solid state slurry process whereby iron ore particles are suspended in an alkaline catholyte to enable solid phase-solid phase interactions. The conversion of iron ore to metallic iron is a function of the rate of reaction (governed by the overpotential and resultant faradaic current), and the residence time of the iron ore particle in the cathodic chamber.

Moreover the reaction rate does not appear to be significantly enhanced by small particle size. Rather the reduction rate appears to be influenced by the contact time of the iron ore particles on the cathode and the frequency of contact with the cathode, the overpotential at the cathode with respect to iron reduction, and the competing hydrogen evolution reaction. A higher particle surface area afforded by smaller particles only moderately increases cathode surface coverage by particles, which is the size-dependent limiting factor.

In one embodiment, the iron ore particles may have a P80 greater than 20 μm, a P80 greater than 45 μm, a P80 greater than 75 μm, a P80 greater than 100 μm, a P80 greater than 200 μm, or even a P80 greater than 250 μm. In one embodiment, the iron ore particles may have a P80 in a range of about 20 μm to about 1000 μm, a P80 in a range of about 75 μm to about 500 μm, or even a P80 in a range of about 100 μm to about 250 μm.

In one embodiment, the iron ore particles suspended in the catholyte may have a solids density of about 1 wt % to about 25 wt %, in particular a solids density of about 10 wt %.

In one embodiment, the iron ore particles may have a residence time of 1 h to 72 h in the cathodic compartment, in particular a residence time of 12 h to 24 h in the cathodic compartment. It will be appreciated that the residence time in the cathodic compartment may be a cumulative period arising from a plurality of shorter periods of residence time in the cathodic compartment over a plurality of cycles.

In one embodiment, the catholyte and the anolyte may be the same or different. The catholyte and the anolyte may independently comprise sodium hydroxide, potassium hydroxide, lithium hydroxide, caesium hydroxide, magnesium hydroxide, calcium hydroxide or a mixture of one or more thereof, optionally in combination with a neutral salt of an alkali metal such as lithium chloride. In one embodiment the catholyte and the anolyte may comprise 20-80 wt % sodium hydroxide or potassium hydroxide solution, in particular 30-60 wt % sodium hydroxide or potassium hydroxide solution. In one embodiment, the catholyte may be carbon free.

In one embodiment, the catholyte and the anolyte may be maintained at a temperature up to the boiling point of the catholyte and the anolyte. For example, the catholyte and the anolyte may be maintained at a temperature from about 80° C. up to 130° C.

In one embodiment, the cathode may comprise a rotating or a non-rotating electrode assembly. The cathode may be formed from a material including, but not limited to, glassy carbon, carbon fibre, graphite, steel, stainless steel or any other grades of steel, or iron, iron alloys or composite materials.

In one embodiment, the anode may comprise a rotating or a non-rotating electrode assembly. The anode may be formed from any suitable non-sacrificial material including, but not limited to, a plate, mesh, net, foam, fibres, sintered particles or other forms of electrode construction from nickel, iron, steel, stainless steel, other grades of steel, nickel-iron alloys, composites or blends, or other metals or conductive materials that are suitable for use as oxygen evolution electrodes in alkaline media.

In one embodiment, the cathode and anode are arranged in parallel alignment with one another. The anode may have a greater electrochemically active surface area than the cathode.

In one embodiment, the separator may comprise any semi-permeable ion conducting membrane suitable for alkaline electrolysis. One suitable example of a semi-permeable ion conducting membrane includes the Zirfon™ (Agfa) separator membrane.

In one embodiment, any one of the steps of circulating the catholyte, circulating the spent catholyte and recirculating the replenished catholyte may be performed at a flow rate that maintains the solid particles of the iron-bearing product and/or the iron ore particles in suspension.

In one embodiment, the separating step may comprise magnetically separating the solid particles of iron-bearing product from the spent catholyte. Alternatively, or additionally, the separating step may comprise filtering the solid particles of iron-bearing product from the spent catholyte or subjecting said suspension to centrifugal separation or cyclonic separation.

In one embodiment, the step of introducing said iron ore particles into the depleted catholyte may be performed continuously or intermittently. It will be appreciated that the iron ore particles may be introduced to the depleted catholyte as a slurry comprising the iron ore particles and the alkaline solution.

In a second aspect there is provided a system for electrolytically producing solid particles of an iron-bearing product from iron ore particles, said system comprising:
an electrochemical flow reactor provided with an electrochemical cell comprising a cathodic compartment and an anodic compartment separated by a separator, wherein the cathodic compartment houses a cathode and the anodic compartment houses an anode;
a catholyte comprising iron ore particles having a particle size P80 of greater than 20 μm suspended in an alkaline solution;
an alkaline anolyte;
a voltage source configured to apply an electrical potential greater than 1.4 V between the cathode and the anode in the electrochemical cell to electrolytically reduce the iron ore particles to solid particles of the iron-bearing product suspended in the alkaline solution thereby producing a spent catholyte;
a separation means in fluid communication with the cathodic compartment to separate the iron-bearing product particles from the spent catholyte and to produce a depleted catholyte; and,
a means to introduce said iron ore particles into the depleted catholyte and thereby replenish said depleted catholyte; wherein said means is in fluid communication with the cathodic compartment in an arrangement whereby a replenished catholyte is re-circulated to the cathodic compartment.

In one embodiment the electrochemical cell comprises an assembly of alternating cathodic compartments and anodic compartments, wherein adjacent cathodic and anodic compartments are separated by respective separators.

### BRIEF DESCRIPTION OF DRAWINGS

Preferred embodiments will now be further described and illustrated, by way of example only, with reference to the accompanying drawings in which:

FIG. 1 is a schematic representation of one embodiment of an electrochemical flow reactor as described herein comprising a single electrochemical cell arranged for co-current flow of the catholyte and anolyte;

FIG. 2 is a schematic representation of another embodiment of the electrochemical flow reactor as described herein comprising a stack of two electrochemical cells with the catholyte and anolyte pumped to header tanks and then gravity fed to the two cell stack;

FIG. 3 is a graphical representation of the total mass of iron-bearing product collected from spent catholyte, plotted against the total charge passed through the electrochemical flow reactor, for a series of examples described herein;

FIG. 4a is an X-ray diffraction (XRD) pattern of an iron-bearing product produced by one embodiment of the process as described herein, as will be described with reference to Experiment 1-14 in Table 6;

FIG. 4b is a magnified view of the X-ray diffraction (XRD) pattern shown in FIG. 4b; and

FIG. 5 is schematic representation of a further embodiment of the electrochemical flow reactor as described herein comprising a stack of two electrochemical cells with co-current flow of the catholyte and anolyte being pumped through the two cell stack.

### DESCRIPTION OF EMBODIMENTS

The present disclosure relates to a process and system for producing solid particles of an iron-bearing product from iron ore particles, in particular a continuous process for producing solid particles of an iron-bearing product from iron ore particles.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Reference to positional descriptions, such as lower and upper, are to be taken in context of the embodiments depicted in the figures, and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”

### Specific Terms

The term ‘iron ore particles’ as used herein refers to iron-bearing minerals including, but not limited to hematite, goethite, magnetite, limonite, taconite, iron aluminosilicate and any other ore types that contain iron oxide.

The term ‘iron-bearing product’ as used herein refers to metallic iron particles or metallic iron particles containing one or more phases of iron oxide including, but not limited to haematite (Fe₂O₃), goethite (FeO(OH)), limonite, taconite and magnetite (Fe₃O₄). Particles of the iron-bearing product may be produced by reducing the iron ore particles in the electrochemical flow reactor via one or more electrochemical reduction steps.

The term ‘anolyte’ as used herein refers to an aqueous salt solution capable of allowing electrons to flow from a positively-charged anode.

As used herein, the term “catholyte” refers to an aqueous salt solution capable of allowing electrons to flow to a negatively-charged cathode.

In the embodiments described herein, the catholyte comprises a suspension of iron ore particles in an alkaline solution, whereby the alkaline solution allows electrons to flow to the negatively-charged cathode and the iron ore particles undergo reduction to the iron-bearing product via one or more electrochemical reduction steps in the cathodic compartment. Accordingly, a reference to the term ‘spent catholyte’, as used herein, refers to said suspension of iron ore particles, wherein the iron ore particles have at least partially undergone one or more reduction reactions. In other words, the spent catholyte may refer to a suspension of iron-bearing product particles in the alkaline solution and/or the alkaline catholyte at least partially depleted in iron ore particles. It will be appreciated by those skilled in the art that the spent catholyte may contain iron-bearing product and unreduced iron ore particles suspended in the alkaline solution. The term ‘depleted catholyte’, as used herein, refers to the spent catholyte from which the iron bearing product has been at least partially separated therefrom.

The term ‘spent anolyte’, as used herein, refers to the second alkaline solution that has undergone one or more oxidation reactions in the anodic compartment of the electrochemical cell.

The term “Px” is defined in the art as a size distribution for which x % of the particles are smaller than the specified value. Accordingly, a P80 of 25 μm means size distribution for which 80% of the particles are smaller than 25 μm.

Process to Produce Iron-Bearing Product from Iron Ore Particles

Materials, methods and techniques as disclosed and contemplated herein relate to a continuous process for electrolytically producing solid particles of an iron-bearing product from iron ore particles.

Exemplary processes as described herein may be performed in an electrochemical flow reactor provided with an electrochemical cell comprising a cathodic compartment and an anodic compartment separated by a separator, wherein the cathodic compartment houses a cathode and the anodic compartment houses an anode.

The electrochemical flow reactor may be configured with a single electrochemical cell (i.e. one cathodic compartment separated from one anodic compartment by a separator). For example, in one form the electrochemical flow reactor may comprise an assembly of a plurality of plates in parallel alignment with one another, said assembly including a compression plate, an isolation plate, an anode plate, a flow plate, a separator, an opposing flow plate, a cathode plate, an opposing isolation plate and an opposing compression plate. The plates are fastened together by means of bolts inserted through aligned holes in the compression plates. The anodic compartment in the single electrochemical cell is defined by the separator and the isolation plate, and the cathodic compartment in the single electrochemical cell is defined by the separator and the opposing isolation plate.

Alternatively, the electrochemical flow reactor may be configured with an assembly of electrochemical cells comprising a plurality of cathodic compartments and anodic compartments as described above in alternating parallel alignment with one another, adjacent cathodic and anodic compartments being separated by a respective separator. In particular, this embodiment conveniently allows the process as described herein to be readily scaled by increasing the number of electrochemical cells in the electrochemical flow reactor, and/or the number of electrochemical flow reactors utilized to convert the iron oxide in the feed stream.

Said assembly comprises an anolyte inlet port and a spent anolyte outlet port in fluid communication with the anolyte compartment(s), and a catholyte inlet port and a spent catholyte outlet port in fluid communication with the cathodic compartment(s). The respective inlets are arranged to allow the anolyte and the catholyte to flow through the respective compartments of the electrochemical cell via a common catholyte delivery line and a common anolyte delivery line, respectively. The respective outlets are arranged to allow the spent anolyte and the spent catholyte to egress the respective compartments of the electrochemical cell via a common spent catholyte return line and a common spent anolyte return line, respectively.

The anodic and cathodic compartments may be provided with thermocouples to measure the temperature of the respective anolyte and catholyte flows.

The cathodic and anodic compartments may be fabricated from any suitable solid material that is chemically inert under the operating conditions of the electrochemical cell. Suitable solid materials include, but are not limited to, glass, metals and alloys or solid plastic materials.

The separator separates the cathodic and anodic compartments to prevent physical contact between the cathode and the anode while allowing transport of ionic charge carriers between the cathodic and anodic compartments. The separator may be any semi-permeable membrane suitable for alkaline electrolysis that allows water, cations and/or anions to pass therethrough. One suitable example of a semi-permeable ion conducting membrane includes the Zirfon™ (Agfa) separator membrane. In use, hydrogen gas may be produced in the cathodic compartment at the cathode as a product of a competing side reaction (i.e. water electrolysis), and oxygen gas may be generated in the anodic compartment due to oxidation of water at the anode. The separator also deters passage of these gases into the other compartments. Gases generated in the electrochemical flow reactor may be either vented or captured via bleed lines (not shown).

Other examples of a suitable separator include, but are not limited to, a porous membrane, an ion exchange membrane (i.e., a non-porous membrane made of polyelectrolyte that absorbs water and ions, as well as preferentially transporting the opposite charge to the charge on the active functional groups of the polyelectrolyte), a salt bridge, a ceramic membrane consisting of clay particles carrying a surface charge, or a composite separator comprising an at least one functional component and optionally at least one non-functional component.

The cathode and the anode may be fabricated from respective electrically conductive materials that are inert or insoluble under alkaline electrolysis conditions maintained in the electrochemical cell. In particular, the cathode may be fabricated from an electrically conductive material having poor catalytic properties for the hydrogen evolution reaction, leading to high overvoltage for hydrogen evolution and surface properties that deter deposition and/or adhesion of the iron-bearing product thereon. Suitable examples of electrically conductive materials from which the cathode may be fabricated include, but are not limited to, glassy carbon, carbon fibre, graphite, steel, stainless steel, other grades of steel, iron, iron alloys or composite materials.

The anode may be fabricated from an electrically conductive material having acceptable catalytic properties towards the oxygen evolution reaction leading to acceptable overvoltage for oxygen evolution and minimum side reactions. Suitable examples of electrically conductive materials from which the anode may be fabricated include, but are not limited to, a plate, mesh, net, foam, fibres, sintered particles or other forms of electrode construction from nickel, iron, steel, stainless steel, other grades of steel, nickel-iron alloys, composites or blends, or other metals or conductive materials including composite materials that can be used as oxygen evolution electrodes in alkaline media

The cathode and the anode may be a rotating electrode assembly. Alternatively, the cathode and the anode may be a non-rotating electrode assembly. In particular, the cathode and the anode may comprise respective stationary plates in parallel alignment with one another and the separator.

Generally, the anode may have a similar or larger electrochemically active surface area to the cathode.

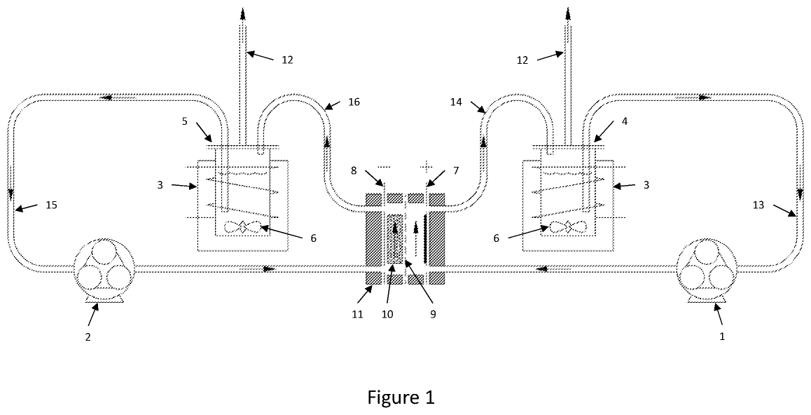

Further embodiments of the electrochemical flow reactor are described in the Example section with reference to FIGS. 1, 2 and 5.

The continuous process for electrolytically producing solids particles of an iron-bearing product from iron ore particles comprises the step of circulating an alkaline catholyte containing iron ore particles suspended therein through the cathodic compartment and circulating an alkaline anolyte through the anodic compartment. It will be appreciated that when said alkaline catholyte is circulated through the cathodic compartment, the cathode and the anode are at least partially in contact with the catholyte and anolyte, respectively.

It will be appreciated that the catholyte and the anolyte may be respectively circulated through the electrochemical flow reactor by any suitable pump including, but not limited to, a peristaltic pump, diaphragm pump, rotary vane pump, centrifugal pump, gear pump, progressive cavity pump or scroll pump.

In particular, the catholyte may be circulated through the cathodic compartment at a flow rate sufficient to maintain the iron ore particles in suspension.

The catholyte and anolyte may be circulated through the respective cathodic and anodic compartments one or more times. Consequently, the iron ore particles suspended in the alkaline solution may have a residence time of 1 h to 72 h in the cathodic compartment, in particular a residence time of 12 h to 24 h in the cathodic compartment. It will be appreciated that the residence time in the cathodic compartment may be a cumulative period arising from a plurality of shorter periods of residence time in the cathodic compartment over a plurality of cycles.

The iron ore particles suspended in the catholyte may have a P80 greater than 20 μm, a P80 greater than 45 μm a P80 greater than 75 μm, a P80 greater than 100 μm, a P80 greater than 200 μm, or even a P80 greater than 250 μm. In various embodiments of the disclosure, the iron ore particles may have a P80 in a range of about 20 μm to about 1000 μm, a P80 in a range of about 75 μm to about 500 μm, or even a P80 in a range of about 100 μm to about 250 μm.

The iron ore particles suspended in the catholyte may have a solids density of about 1 wt % to about 25 wt %, in particular a solids density of about 10 wt %.

The catholyte and the anolyte may be the same or different. The catholyte and the anolyte may independently comprise sodium hydroxide, potassium hydroxide, lithium hydroxide, caesium hydroxide, magnesium hydroxide, calcium hydroxide or a mixture of one or more thereof, optionally in combination with a neutral salt of a alkali metal such as lithium chloride. In one embodiment the catholyte and the anolyte may comprise 20-80 wt % sodium hydroxide or potassium hydroxide solution, in particular 30-60 wt % sodium hydroxide or potassium hydroxide solution. In one embodiment, the catholyte may be carbon free.

The catholyte and the anolyte may be maintained at a temperature up to the boiling point of the catholyte and the anolyte. For example, the catholyte and the anolyte may be maintained at a temperature from about 80° C. up to 130° C. To maintain the temperature the electrochemical flow reactor may be equipped with a heating means such as a heat exchanger through which the catholyte, anolyte and/or replenished catholyte can be circulated.

Furthermore, it will be appreciated that a heating means may be associated with the electrochemical cell to maintain the anolyte and the catholyte at a desired temperature. Suitable heating means includes, but is not limited to, a heating jacket, heating mantle or heating plate configured in a suitable arrangement to heat the electrochemical cell.

The process as described herein comprises the step of applying an electrical potential greater than 1.4V between the cathode and the anode in the electrochemical cell to electrolytically reduce the iron ore particles to solid particles of the iron-bearing product suspended in the alkaline solution, thereby producing spent catholyte.

A suitable power supply (not shown) may be configured in electrical communication with the cathode(s) and the anode(s) to supply a desired cell potential of greater than 1.4 to the electrochemical cell(s) to maintain a desired current density of about 0.1 A/cm² to about 1.0 A/cm².

In particular, the electrical potential applied between the cathode and the anode in the electrochemical cell may be greater than 1.45 V, greater than 1.50 V, greater than 1.55 V, greater than 1.60 V, greater than 1.65 V, greater than 1.70 V, greater than 1.75 V, greater than 1.80 V, greater than 1.85 V, greater than 1.85 V, greater than 1.90 V, greater than 1.95 V, greater than 2.00 V, greater than 2.05 V, greater than 2.10 V, greater than 2.15 V, greater than 2.20 V, greater than 2.25 V, greater than 2.30 V, greater than 2.35 V, greater than 2.40 V, greater than 2.45 V, or even up to about 2.50 V,

In particular, the electrical potential applied between the cathode and the anode in the electrochemical cell may be 1.45 V to 2.5 V, 1.50 V to 2.5 V, 1.55 V to 2.5 V, 1.60 V to 2.5 V, 1.65 V to 2.5 V, 1.7 V to 2.5V, 1.75 V to 2.5 V, 1.8 V to 2.5 V, 1.85 V to 2.5 V, 1.90 V to 2.5 V, 1.95 V to 2.5 V, 2.0 V to 2.5 V, 2.05 V to 2.5 V, 2.1 V to 2.5 V, 2.15 V to 2.5 V, 2.2 V to 2.5 V, 2.25 V to 2.5 V, 2.3 V to 2.5 V, 2.35 V to 2.5 V, 2.4 V to 2.5 V, even 2.45 V to 2.5 V.

The anode and cathode may be associated with a current collector configured to electrically connect the anode and the cathode to the power supply.

It will be appreciated that the electrochemical cells of the electrochemical flow reactor may be electrically connected in series.

The spent catholyte may be circulated to a suitable separation means so that the iron-bearing product may be separated from the spent catalyst. The separating step may be performed by any suitable separation means including, but not limited to, magnetic separation, filtration, centrifugal separation and cyclonic separation or a combination of separation means. The separation means may separate the iron-bearing product from the spent catholyte in a batch or continuous (in-line) mode

The iron-bearing product may be conveniently separated by magnetically separating the solid particles of iron-bearing product from the spent catholyte. The iron-bearing product may be washed and dried, preferably under an inert non-oxidising atmosphere to prevent re-oxidation of said iron-bearing product.

Iron ore particles may be introduced into the depleted catholyte, and the resulting replenished catholyte may be recirculated to the cathodic compartment. The iron ore particles may be continuously introduced into the depleted catholyte. Alternatively, the iron ore particles may be intermittently introduced into the depleted catholyte. The iron ore particles may be introduced as a slurry comprising the iron ore particles and the alkaline solution.

### EXAMPLES

The following examples are to be understood as illustrative only. It should therefore not be construed as limiting the embodiments of the disclosure in any way.

### Iron Ore Composition

A variety of iron ore samples were used in a series of experiments to demonstrate the processes as described herein. The iron ore samples are representative only and it will be appreciated that the chemical composition of samples may vary between samples taken from the same iron ore deposit.

The synthetic iron ore sample used in Experiments 1-01 to 1-04 summarized in Table 6 and Experiments 2-01 to 2-03 summarized in Table 7 had a chemical composition of 65% goethite and 35% hematite.

Table 1 lists the chemical composition of iron ore samples used in Experiments 1-05 to 1-26 summarised in Table 6, and Experiments 2-04 to 2-11 summarised in Table 7.

TABLE 1
Iron Ore Sample A

| Component | % |
|---|---|
| Fe (elemental) | BDL |
| Fe (as goethite/hematite) | 54.91 |
| SiO2 | 5.62 |
| Al2O3 | 2.78 |
| TiO2 | 0.11 |
| Mn | 3.29 |

BDL: Below detection limit (<0.1%)
Balance of mass may have included oxides, water, and low percentage (<1%) impurities.

The iron ore samples used in Experiment 1-27 as summarised in Table 6 and in Experiment 2-12 as summarised in Table 7 below had a chemical composition as shown in Table 2.

TABLE 2
Iron Ore Sample B

| Component | % |
|---|---|
| Fe (elemental) | BDL |
| Fe (as magnetite) | 64.3 |
| SiO2 | 7.5 |
| Siderite (FeCO3) | 2.7 |

BDL: Below detection limit (<0.1%)
Balance of mass may have included oxides, water, and low percentage (<1%) impurities.

The iron ore sample used in Experiment 1-28 summarised in Table 6 below had a chemical composition as shown in Table 3.

TABLE 3
Iron Ore Sample C

| Component | % |
|---|---|
| Fe (elemental) | BDL |
| Fe (as goethite/hematite) | 60.18 |
| SiO2 | 4.67 |
| Al2O3 | 2.28 |
| TiO2 | 0.13 |
| Mn | 0.07 |

BDL: Below detection limit (<0.1%)
Balance of mass may have included oxides, water, and low percentage (<1%) impurities.

The iron ore samples used in Experiment 1-29 as summarised in Table 6 below had a chemical composition as shown in Table 4.

TABLE 4
Iron Ore Sample D

| Component | % |
|---|---|
| Fe (elemental) | BDL |
| Fe (as goethite/hematite) | 43.6 |
| SiO2 | 28.4 |
| Al2O3 | 5.7 |

BDL: Below detection limit (<0.1%)
Balance of mass may have included oxides, water, and low percentage (<1%) impurities.

The iron ore samples used in Experiment 1-30 summarised in Table 6 below had a chemical composition as shown in Table 5.

TABLE 5
Iron Ore Sample E

| Component | % |
|---|---|
| Fe (elemental) | BDL |
| Fe (as goethite/hematite) | 45.76 |
| SiO2 | 14.16 |
| Al2O3 | 7.47 |
| Mn | 1.74 |

BDL: Below detection limit (<0.1%)
Balance of mass may have included oxides, water, and low percentage (<1%) impurities.

### Example 1

Referring to FIG. 1, there is shown a small scale electrochemical flow reactor comprising a single electrochemical cell arranged for co-current flow of the catholyte and anolyte. The electrochemical flow reactor included an electrochemical cell 11 having a cathodic compartment and an anodic compartment separated by a separator 9. The anodic compartment included an anode plate 8, and in some cases (as indicated in Table 6) the anode comprised a piece of nickel foam 10 in electrical communication with the anode plate 8. The cathodic compartment included a carbon fibre cathode plate 7.

A catholyte comprising different solids concentrations of iron ore particles in 50 wt % sodium hydroxide was stored in a sealed catholyte reservoir 4 provided with: (i) a mantle heater 3 to maintain the catholyte at the desired temperature; (ii) a magnetic stirrer 6 to stir the catholyte and maintain the iron ore particles in suspension; and (iii) a vapour vent line 12. The catholyte is circulated from the sealed catholyte reservoir 4 to the cathodic compartment via a catholyte feed line 13 by a catholyte peristaltic pump 1. Spent catholyte is circulated from the cathodic compartment to said reservoir 4 via a catholyte return line 14.

The anolyte comprising 50 wt % sodium hydroxide is stored in a sealed anolyte reservoir 5 provided with: (i) a mantle heater 3 to maintain the anolyte at the desired temperature; (ii) a magnetic stirrer 6 to stir the anolyte; and (iii) a vapour vent line 12. The anolyte is circulated from the anolyte reservoir 5 to the anodic compartment via an anodic feed line 15 by anolyte peristaltic pump 2. Spent anolyte is circulated from the anodic compartment to said reservoir 5 via an anolyte return line 16.

A series of 18 g iron ore samples of either synthetic iron ore or different mined iron ore samples as described in Tables 1-5 above having P80 particle sizes in a range of 2 μm to 200 μm were suspended in a pre-heated aqueous solution of 50 wt % NaOH (220 g) inside a Teflon beaker. The resulting slurry was stirred using a magnetic stirring bar placed at the bottom of the beaker under 300 rpm. The slurry was stirred for a minimum of 5 minutes to ensure homogenous dispersion of the iron ore particles.

The catholyte as prepared above was placed into the catholyte footer tank 23 and heated to the desired temperature (~100° C.).

The catholyte was circulated through the cathodic compartment of the single-cell electrochemical flow reactor shown in FIG. 1. The cathode was carbon fibre with an area of 20.4 cm². The anode disposed in the anodic compartment was either a nickel plate anode or nickel foam anode having an area of 20.4 cm². The anolyte circulated through the anodic compartment was an aqueous solution of 50 wt % NaOH.

The catholyte and the anolyte were circulated at a constant flow rate and were maintained at a constant temperature greater than 90° C. and ambient pressure. A fixed potential of 1.75 V or 1.95 V was then applied to the anode and the cathode as the heated catholyte and the heated anolyte were circulated through the cathodic compartment and the anodic compartment, respectively. The electrochemical flow reactor was held under these conditions for several hours (see Table 5), during which time a measured amount of charge was passed through the circuit. At the completion of the experiment, a magnet was immersed in the spent catholyte and solid particles of the iron-bearing product was separated therefrom. The separated iron-bearing product was washed, filtered and dried.

### Example 1 Product Analysis

The iron-bearing product was characterised by XRD and the relative concentrations of the iron-based materials in the product were determined by the Rietveld refinement method (see Rietveld, H. M. (2 Jun. 1969). “A profile refinement method for nuclear and magnetic structures”. Journal of Applied Crystallography. 2 (2): 65-71). The iron-bearing product was also characterised by bromine digestion using a method based on ISO 5416 Determination of Metallic Iron, wherein the dissolved iron concentration was determined by Inductively Coupled Plasma Optical Emission Spectroscopy (ICP-OES) instead of titrimetric analysis.

The experimental parameters and amount of metallic iron and magnetite found in the iron-bearing products produced by each experiment are listed in Table 6.

The mass of metallic iron collected was used to calculate the Faradaic Efficiency limited to the generation and subsequent recovery of iron in the iron-bearing product present in the catholyte using equation (2):

$$Faradaic Efficiency = ( {m}_{Fe} / {AW}_{Fe} ) / ( C \times 3 F ) \qquad ( 2 )$$

Wherein m_{Fe} is the mass in grams of iron collected from the catholyte, AW_{Fe} is the atomic weight of iron, C is the total charge (in A.s) passed through the electrode, F is the Faraday constant, and the number 3 is the initial average oxidation state of the iron atoms in the catholyte. Note that the calculated values for Faradaic Efficiency shown in Table 6 do not take into account any partially-reduced iron ore (for example, haematite and/or goethite that have been reduced to magnetite), or any iron or magnetite that was not recovered by the separation process and is still available to be recovered at later stages of the process, for example after additional ongoing circulation and residence time in the cathodic compartment.

TABLE 6

| | | | | flow | | | | | mass | | | | | | |
|---|---|---|---|---|---|---|---|---|---|---|---|---|---|---|---|
| | | Solids | | rate | | Expt. | Applied | | of | | mass | Faradaic | % | mass | Ore |
| Expt. | P size | content | | mL/ | temp | time | potential | charge | prod. | % iron | iron | efficiency | magnetite | magnetite | type |
| No# | μm | wt % | anode | min | ° C. | h | V | A · h | mg | w/w | mg | % | w/w | mg | N/A |
| 1-01 | 2 | 7.6 | nickel | 160 | 93 | 8.5 | 1.75 | 4.642 | 40 | 93.3 | 37.6 | 1.17% | 3.2 | 1.3 | Synth. |
| | | | plate | | | | | | | | | | | | |
| 1-02 | 2 | 7.6 | nickel | 160 | 110 | 4.5 | 1.75 | 7.17 | 7 | 97.2 | 6.9 | 0.14% | 0 | 0 | Synth. |
| | | | foam | | | | | | | | | | | | |
| 1-03 | 2 | 7.6 | nickel | 160 | 99 | 8 | 1.75 | 17.03 | 25 | 74.9 | 19.0 | 0.16% | 17 | 4 | Synth. |
| | | | plate | | | | | | | | | | | | |
| 1-04 | 2 | 7.6 | nickel | 160 | 100 | 7 | 1.75 | 5.944 | 8 | 100 | 8.2 | 0.20% | 0 | 0 | Synth. |
| | | | plate | | | | | | | | | | | | |
| 1-05 | 20 | 7.6 | nickel | 132 | 93 | 2 | 1.75 | 2.167 | 150 | 4.4 | 6.6 | 0.44% | 29 | 44 | A |
| | | | plate | | | | | | | | | | | | |
| 1-06 | 100 | 7.6 | nickel | 132 | 91 | 3 | 1.75 | 2.056 | 112 | 5.6 | 6.3 | 0.44% | 41 | 45 | A |
| | | | plate | | | | | | | | | | | | |
| 1-07 | 100 | 7.6 | nickel | 132 | 92 | 3.5 | 1.75 | 3.685 | 242 | 3.9 | 9.4 | 0.37% | 20 | 49 | A |
| | | | plate | | | | | | | | | | | | |
| 1-08 | 75 | 7.6 | nickel | 132 | 98 | 3 | 1.75 | 1.231 | 148 | 8.7 | 12.9 | 1.51% | 26 | 38 | A |
| | | | plate | | | | | | | | | | | | |
| 1-09 | 45 | 7.6 | nickel | 132 | 100 | 3 | 1.75 | 1.702 | 180 | 13.3 | 23.9 | 2.02% | 24 | 42 | A |
| | | | plate | | | | | | | | | | | | |
| 1-10 | 20 | 7.6 | nickel | 276 | 88 | 6 | 1.75 | 3.098 | 98 | 3.8 | 3.7 | 0.17% | 36 | 35 | A |
| | | | plate | | | | | | | | | | | | |
| 1-11 | 8 | 7.6 | nickel | 480 | 107 | 5 | 1.75 | 10.975 | 40 | 27.3 | 10.9 | 0.14% | 7 | 3 | A |
| | | | plate | | | | | | | | | | | | |
| 1-12 | 100 | 7.6 | nickel | 160 | 100 | 6 | 1.75 | 2.82 | 451 | 2 | 9.0 | 0.46% | 24 | 110 | A |
| | | | plate | | | | | | | | | | | | |
| 1-13 | 8 | 7.6 | nickel | 160 | 101 | 6 | 1.75 | 4.033 | 68 | 19.2 | 13.1 | 0.47% | 42 | 29 | A |
| | | | plate | | | | | | | | | | | | |
| 1-14 | 20 | 7.6 | nickel | 160 | 100 | 4 | 1.95 | 5 | 762 | 7.4 | 56.4 | 1.62% | 13 | 101 | A |
| | | | plate | | | | | | | | | | | | |
| 1-15 | 100 | 7.6 | nickel | 160 | 100 | 3.5 | 1.95 | 10.13 | 7404 | 2.4 | 178 | 2.53% | 34 | 2480 | A |
| | | | foam | | | | | | | | | | | | |
| 1-16 | 75 | 7.6 | nickel | 160 | 100 | 7 | 1.95 | 22.26 | 2110 | 4.9 | 103 | 0.67% | 6 | 127 | A |
| | | | foam | | | | | | | | | | | | |
| 1-17 | 45 | 7.6 | nickel | 160 | 100 | 4 | 1.95 | 10.56 | 122 | 15.9 | 19.4 | 0.26% | 20 | 24 | A |
| | | | foam | | | | | | | | | | | | |
| 1-18 | 100 | 7.6 | nickel | 160 | 100 | 7 | 1.95 | 22.26 | 3290 | 25.7 | 845.5 | 5.47% | 33 | 1073 | A |
| | | | foam | | | | | | | | | | | | |
| 1-19 | 45 | 7.6 | nickel | 160 | 100 | 6 | 1.95 | 22.26 | 189 | 48.6 | 91.9 | 0.59% | 11 | 20 | A |
| | | | foam | | | | | | | | | | | | |
| 1-20 | 100 | 7.6 | nickel | 480 | 100 | 5 | 1.95 | 22.32 | 2333 | 6.8 | 158.6 | 1.02% | 16 | 373 | A |
| | | | foam | | | | | | | | | | | | |
| 1-21 | 200 | 7.6 | nickel | 160 | 100 | 14 | 1.95 | 42.73 | 1242 | 35.9 | 445.9 | 1.50% | 4 | 55 | A |
| | | | foam | | | | | | | | | | | | |
| 1-22 | 20 | 7.6 | nickel | 160 | 100 | 4 | 2.1 | 20.92 | 1950 | 8.5 | 165.8 | 1.14% | 25 | 491 | A |
| | | | foam | | | | | | | | | | | | |
| 1-23 | 20 | 7.6 | nickel | 160 | 100 | 12 | 1.95 | 31.22 | 669 | 55.1 | 368.6 | 1.70% | 0.6 | 4 | A |
| | | | foam | | | | | | | | | | | | |
| 1-24 | 20 | 20 | nickel | 160 | 100 | 8 | 1.95 | 20.17 | 981 | 2.7 | 26.5 | 0.19% | 23.4 | 229.6 | A |
| | | | foam | | | | | | | | | | | | |
| 1-25 | 150 | 7.6 | nickel | 160 | 101 | 12 | 1.95 | 30 | 2683 | 11.6 | 311.2 | 1.49% | 69 | 1849 | A |
| | | | foam | | | | | | | | | | | | |
| 1-26 | 20 | 25 | nickel | 160 | 100 | 7 | 1.95 | 19.71 | 1950 | 0.6 | 11.7 | 0.09% | 22 | 433 | A |
| | | | foam | | | | | | | | | | | | |
| 1-27 | 100 | 7.6 | nickel | 160 | 100 | 11 | 1.95 | 20.18 | 9930 | 36.4 | 3615 | 25.79% | 34 | 3396 | B |
| | | | foam | | | | | | | | | | | | |
| 1-28 | 100 | 7.6 | nickel | 160 | 100 | 8 | 1.95 | 20.01 | 4619 | 25.8 | 1192 | 8.57% | 51 | 2356 | C |
| | | | foam | | | | | | | | | | | | |
| 1-29 | 100 | 7.6 | nickel | 160 | 100 | 9 | 1.95 | 20.03 | 1829 | 0.3 | 5.5 | 0.04% | 23 | 419 | D |
| | | | foam | | | | | | | | | | | | |
| 1-30 | 100 | 7.6 | nickel | 160 | 100 | 11 | 1.95 | 20.36 | 135 | 0.5 | 0.7 | 0.00% | 0 | 1 | E |
| | | | foam | | | | | | | | | | | | |

### Example 2

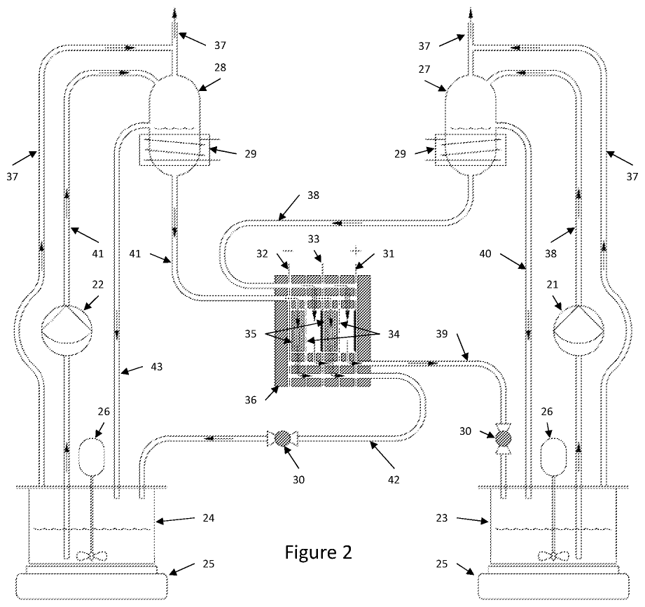

Referring to FIG. 2, there is shown an electrochemical flow reactor comprising a dual electrochemical cell arranged for co-current flow of the catholyte and anolyte. The electrochemical flow reactor includes an electrochemical cell housing 36 having alternating cathodic compartments and anodic compartments separated by a respective separator 34. Adjacent electrochemical cells are separated by a bipolar plate 33. The anodic compartments include an anode plate 32 in electrical communication with a piece of nickel foam 35. The cathodic compartment included a carbon fibre cathode plate 31. The outermost cells of a multicell electrochemical flow reactor were contacted on their outer electrode (the anode at the positive end and the cathode at negative end) by a current collector that was between the electrochemical cells in the stack and the electrical power source.

A catholyte comprising 1 wt % or 10 wt % iron ore particles (solids content is specified in Table 7 for each experiment) in 50 wt % sodium hydroxide is stored in a sealed catholyte footer tank 23 provided with: (i) a plate heater 25 to maintain the catholyte at the desired temperature; (ii) an agitator such as an impeller 26 to stir the catholyte and maintain the iron ore particles in suspension; and (iii) a vapour vent line 37. The catholyte is pumped from the sealed catholyte footer tank 23 to a catholyte header tank 27 via a catholyte feed line 38 by catholyte diaphragm pump 21. The catholyte header tank 27 is provided with a heating mantle 29 to maintain the catholyte at the desired temperature. The catholyte is fed via gravity from the catholyte header tank 37 to the cathodic compartments via the catholyte feed line 38. Catholyte overflow may be directed from the catholyte header tank 27 to the sealed catholyte footer tank 23 via overflow line 40. Spent catholyte is circulated from the cathodic compartment to the sealed catholyte footer tank 23 via a catholyte return line 39.

The anolyte comprising 50 wt % sodium hydroxide is stored in a sealed anolyte footer tank 24 provided with: (i) a plate heater 25 to maintain the anolyte at the desired temperature; (ii) an agitator such as an impeller 26 to stir the anolyte; and (iii) a vapour vent line 37. The anolyte is pumped from the sealed anolyte footer tank 24 to an anolyte header tank 28 via an anolyte feed line 41 by an anolyte diaphragm pump 22. The anolyte header tank 28 is provided with a heating mantle 29 to maintain the anolyte at the desired temperature. The anolyte is fed via gravity from the anolyte header tank 28 to the anodic compartments via the anodic feed line 41. Anolyte overflow may be directed from the anolyte header tank 28 to the sealed anolyte footer tank 24 via overflow line 43. Spent anolyte is circulated from the anodic compartment to the sealed anolyte footer tank 28 via an anolyte return line 42.

The catholyte was prepared by placing 50 wt % NaOH into the catholyte footer tank 23 and heating to the desired temperature (~100° C.). The desired amount of iron ore particles (500 g) having P80 particle sizes in a range of 2 μm to 250 μm was added to the tank over five minutes with stirring to agitate the suspension. The anolyte was added to the anolyte footer tank 24 as an aqueous solution of 50 wt % NaOH. The catholyte and the anolyte were pumped to header tanks by diaphragm pumps as shown in FIG. 2. The catholyte and anolyte were gravity fed to the cathodic and anodic compartments, respectively, of either a single-cell electrochemical flow cell (as indicated in Table 7), or a dual electrochemical cell stack as shown in FIG. 2 and as indicated in Table 7. The temperature at the inlet and the outlet of each cell was monitored and used to maintain the cell at the desired temperature of at least 85° C. or higher. Pressure was also monitored at the inlet and the outlet of each cell. The flow rate of the catholyte slurry was measured prior to the electrochemical flow cell through flow meters (not shown). The reactor, lines and source container were all insulated to minimize heat loss. The desired flow rate was achieved through the adjustment of the valves 30.

The cathode was formed from carbon fibre with an area of 111 cm². The anode disposed in the anodic compartment was either a nickel plate anode or nickel foam anode having an area of 111 cm².

A fixed potential of 1.65 V or 1.75 V per cell, as specified for each experiment in Table 7, was then applied between the anode(s) and respective cathode(s) as the heated catholyte and the heated anolyte were circulated through the cathodic compartments and the anodic compartments, respectively. The electrochemical flow reactor was held under these conditions for several hours (see Table 7), during which time a measured amount of charge was passed through the circuit. At the completion of the experiment, a magnet was immersed in the spent catholyte and iron-bearing product was separated therefrom. The separated iron-bearing product was washed, filtered and dried.

### Example 2 Product Analysis

The iron-bearing product was characterised by XRD and the relative concentrations of the iron-based materials in the sample were determined by the Rietveld refinement method (see Rietveld, H. M. (2 Jun. 1969). “A profile refinement method for nuclear and magnetic structures”. Journal of Applied Crystallography. 2 (2): 65-71). The iron-bearing product was also characterised by bromine digestion using a method based on ISO 5416 Determination of Metallic Iron, wherein the dissolved iron concentration was determined by Inductively Coupled Plasma Optical Emission Spectroscopy (ICP-OES) instead of titrimetric analysis.

The experimental parameters and amount of metallic iron and magnetite found in the iron-bearing products produced by each experiment are listed in Table 7.

The mass of metallic iron collected was used to calculate an effective Faradaic efficiency using equation (2) as described above. Note that the calculated values for Faradaic Efficiency shown in Table 7 do not take into account any partially-reduced iron ore (for example, haematite and/or goethite that have been reduced to magnetite), or any iron or magnetite that was not recovered by the separation process and is still available to be recovered at later stages of the process, for example after additional ongoing circulation and residence time in the cathodic compartment.

TABLE 7

| | | | | | | | | mass | | | | | | |
|---|---|---|---|---|---|---|---|---|---|---|---|---|---|---|
| | | P | % | | Expt. | applied | | of | % | mass | Faradaic | % | mass | Ore |
| Expt | # | size | Solids | temp | time | potential | charge | prod. | iron | iron | efficiency | magnetite | magnetite | type |
| No.# | cells | μm | w/w | ° C. | h | V/cell | A · h | g | w/w | mg | % | w/w | mg | N/A |
| 2-01 | 1 | 2 | 10 | 102 | 2.4 | 1.75 | 11.0 | 1.8 | 1.2 | 22 | 0.3% | 31 | 1174 | Synth. |
| 2-02 | 2 | 2 | 10 | 99 | 4.7 | 1.75 | 42.1 | 4.5 | 34.6 | 1557 | 5.3% | 58 | 549 | Synth. |
| 2-03 | 1 | 2 | 10 | 101 | 8 | 1.75 | 24.0 | 1.7 | 4.9 | 83 | 0.5% | 76 | 366 | Synth. |
| 2-04 | 1 | 20 | 10 | 85 | 4 | 1.65 | 2.5 | 32 | 0.7 | 222 | 12.8% | 62 | 3043 | A |
| 2-05 | 2 | 12 | 10 | 100 | 4 | 1.75 | 36.5 | 6.2 | 34.9 | 2164 | 8.5% | 35 | 1066 | A |
| 2-06 | 2 | 20 | 10 | 101 | 4.8 | 1.75 | 37.8 | 72 | 5.2 | 3754 | 14.3% | 65 | 10397 | A |
| 2-07 | 2 | 75 | 10 | 102 | 4 | 1.75 | 35.8 | 17 | 1.5 | 260 | 1.0% | 56 | 156 | A |
| 2-08 | 1 | 20 | 1 | 102 | 4 | 1.75 | 6.4 | 1.0 | 58.1 | 581 | 13.1% | 69 | 202 | A |
| 2-09 | 1 | 20 | 10 | 96 | 3.5 | 1.75 | 7.2 | 22 | 3.9 | 858 | 17.2% | 66 | 3036 | A |
| 2-10 | 1 | 75 | 10 | 100 | 5.9 | 1.75 | 23.1 | 24 | 1.6 | 389 | 2.4% | 50 | 2284 | A |
| 2-11 | 2 | 250 | 10 | 101 | 4 | 1.75 | 44.6 | 337 | 0.1 | 337 | 1.1% | 34 | 0 | A |
| 2-12 | 1 | 100 | 10 | 103 | 4 | 1.75 | 10.7 | 387.2 | 0.1 | 387 | 5.2% | 14.6 | 326000 | B |

As can be seen from Tables 6 and 7, the iron-bearing product is continually produced in the catholyte as it circulates through the cathodic compartment(s) of the electrochemical flow reactors shown in FIGS. 1 and 2.

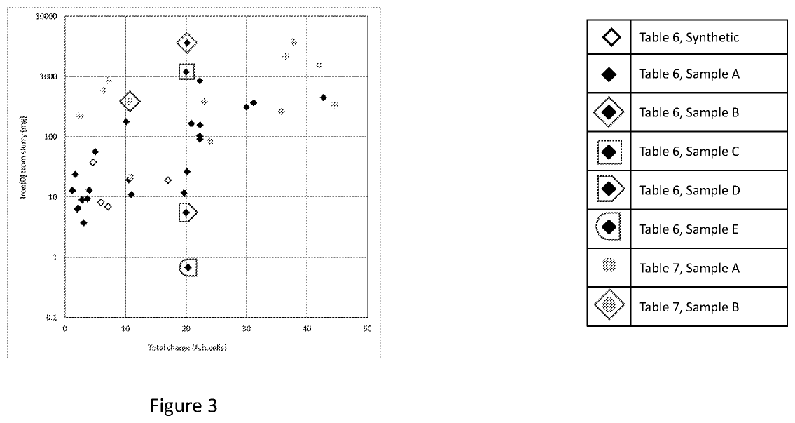

A graphical representation of the total mass of iron-bearing product collected from the spent catholyte from each experiment summarised in Table 6 and Table 7 plotted against the total charge passed through the electrochemical flow reactors in the various experiments is shown in FIG. 3. Experimental results from Table 6 are indicated by black diamonds and experimental results from Table 7 are indicated by grey circles. The type of iron ore used in each experiment is also indicated by symbols as defined in the legend for FIG. 3.

Iron-bearing product samples were also characterized by x-ray diffraction to determine the relative amounts of goethite, haematite, magnetite and metallic iron in the separated iron-bearing product.

The quantity of Fe(0) collected in the product was further confirmed by extraction into a fixed volume of bromine using a modified method based on ISO 5416 Determination of Metallic Iron, and the dissolved iron concentration was determined by Inductively Coupled Plasma Optical Emission Spectroscopy (ICP-OES).

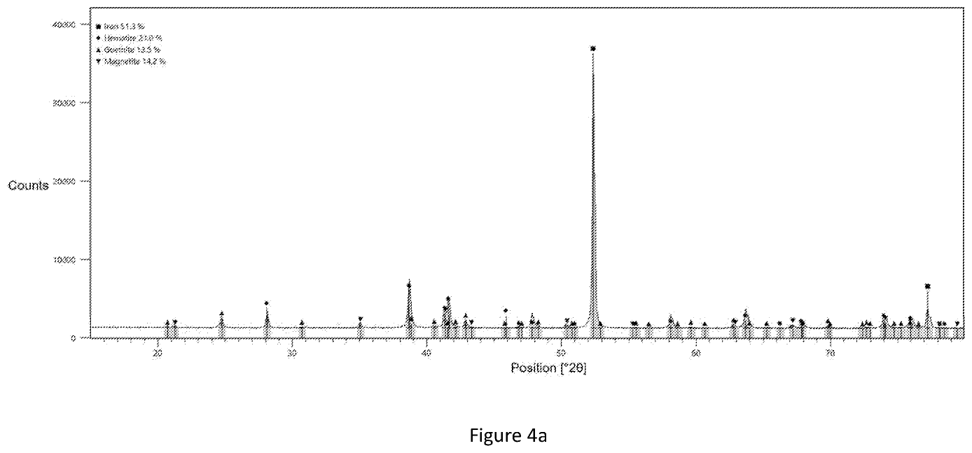

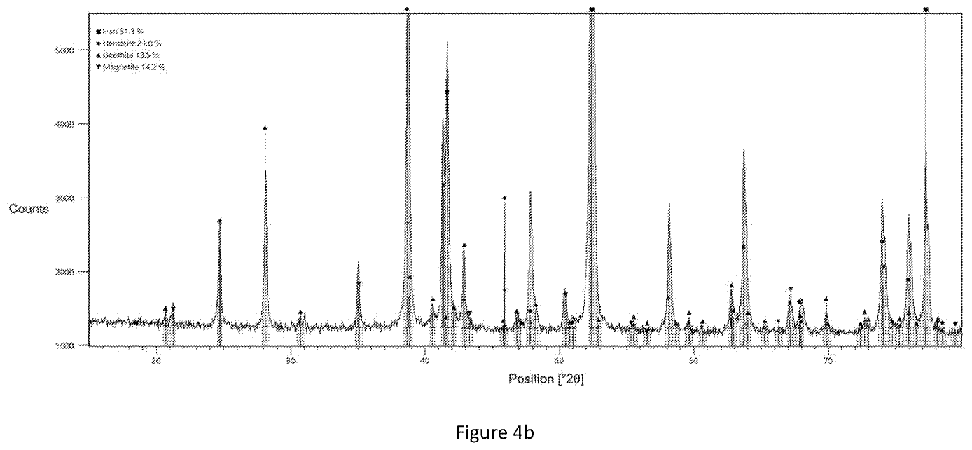

FIG. 4a shows an X-ray diffraction (XRD) trace for Experiment 1-14 in Table 1 that shows diffraction peaks corresponding to hematite, goethite, magnetite and iron. The relative concentrations of each in the product were determined by the Rietveld refinement method.

The inventors have noted that shorter residence times have lower apparent Faradaic Efficiency. Operating a flow cell for a longer period or increasing the amount of charge results in increased amounts of iron-bearing product produced in the catholyte. The observed current density is variable, likely due to one or more factors including effectiveness of electrode flooding, quality of electrochemical cell assembly, applied voltage, and/or increased hydrogen gas evolution with time due to increased iron deposition on the cathode. The Faradaic Efficiency may also be variable as a function of the applied voltage and iron-bearing product adhering to the cathode surface.

### Example 3

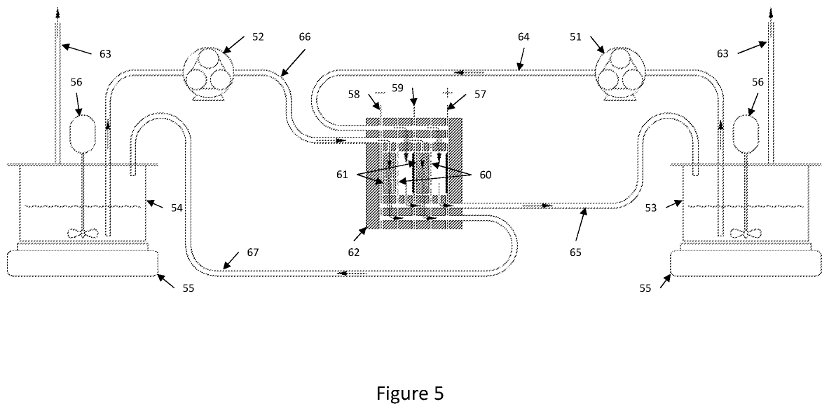

Referring to FIG. 5, there is shown an electrochemical flow reactor comprising a dual electrochemical cell arranged for co-current flow of the catholyte and anolyte. It differs from the electrochemical flow reactor shown in FIG. 2 in that the flow of anolyte and catholyte to the anodic compartments and cathodic compartments is delivered via a pump rather than being gravity-fed as shown in FIG. 2.

The electrochemical flow reactor includes an electrochemical cell housing 62 having alternating cathodic compartments and anodic compartments separated by a respective separator 60. Adjacent electrochemical cells are separated by a bipolar plate 59. The anodic compartments include an anode plate 58 in electrical communication with a piece of nickel foam 61. The cathodic compartment includes a cathode plate 57. The outermost cells of the multicell electrochemical flow reactor may be contacted on their outer electrode (the anode at the positive end and the cathode at negative end) by a current collector that is between the electrochemical cells in the stack and the electrical power source (not shown) that applies a cell potential across the electrodes.

A catholyte comprising 10 wt % iron ore particles in 50 wt % sodium hydroxide may be stored in a sealed catholyte tank 53 provided with: (i) a plate heater 55 to maintain the catholyte at the desired temperature; (ii) an agitator such as an impeller 56 to stir the catholyte and maintain the iron ore particles in suspension; and (iii) a vapour vent line 63. The catholyte may be pumped from the sealed catholyte tank 53 to the cathodic compartments via a catholyte feed line 64 by catholyte peristaltic pump 51. Spent catholyte may be circulated from the cathodic compartment to the sealed catholyte tank 53 via a spent catholyte return line 65.

The anolyte comprising 50 wt % sodium hydroxide may be stored in a sealed anolyte tank 54 provided with: (i) a plate heater 55 to maintain the anolyte at the desired temperature; (ii) an agitator such as an impeller 56 to stir the anolyte; and (iii) a vapour vent line 63. The anolyte may be pumped from the sealed anolyte tank 54 to the anodic compartments via an anolyte feed line 66 by an anolyte peristaltic pump 52. Spent anolyte may be circulated from the anodic compartment to the sealed anolyte tank 54 via an anolyte return line 67.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A continuous process for electrolytically producing solid particles of an iron-bearing product from iron ore particles, the process comprising:
providing an electrochemical flow reactor provided with an electrochemical cell comprising a cathodic compartment and an anodic compartment separated by a separator, wherein the cathodic compartment houses a cathode at least partially in contact with an alkaline catholyte comprising iron ore particles having a particle size P80 of greater than 20 μm suspended therein and the anodic compartment houses an anode at least partially in contact with an alkaline anolyte;
circulating the alkaline catholyte through the cathodic compartment;
applying an electrical potential greater than 1.4V between the cathode and the anode in the electrochemical cell and electrolytically reduce the iron ore particles to solid particles of the iron-bearing product suspended in the catholyte thereby producing a spent catholyte;
circulating the spent catholyte to a separation means and separating the iron-bearing product particles from the spent catholyte to produce a depleted catholyte; and,
introducing said iron ore particles into the depleted catholyte to produce a replenished catholyte and recirculating the replenished catholyte to the cathodic chamber.

2. The process according to claim 1, wherein the iron ore particles have a P80 greater than 75 μm.

3. The process according to claim 1, wherein the iron ore particles suspended in the catholyte have a solids density from about 1 wt % to about 25 wt %.

4. The process according to claim 1, wherein the electrical potential applied between the cathode and the anode in the electrochemical cell is 1.5V-2.5 V.

5. The process according to claim 1, wherein the electrical potential applied between the cathode and the anode in the electrochemical cell is 1.75V-2.5 V.

6. The process according to claim 1, wherein the iron ore particles have a residence time of 1 h to 72 h in the cathodic compartment.

7. The process according to claim 1, wherein the catholyte and the anolyte independently comprise sodium hydroxide, potassium hydroxide, lithium hydroxide, caesium hydroxide, magnesium hydroxide, calcium hydroxide or a mixture of one or more thereof, optionally in combination with a neutral salt of an alkali metal such as lithium chloride.

8. The process according to claim 7, wherein the catholyte and the anolyte comprise 20-80 wt % sodium hydroxide or potassium hydroxide solution.

9. The process according to claim 1, wherein the catholyte is carbon free.

10. The process according to claim 1, wherein the catholyte and the anolyte are maintained at a temperature up to their boiling point.

11. The process according to claim 1, wherein the separating step comprises magnetically separating the solid particles of iron-bearing product from the spent catholyte, optionally in combination with filtering the solid particles of iron-bearing product from the spent catholyte or subjecting said suspension to centrifugal separation or cyclonic separation.

12. The process according to claim 1, wherein the step of introducing said iron ore particles into the depleted catholyte is performed continuously or intermittently.

13. The process according to claim 12, wherein the iron ore particles are introduced as a slurry comprising the iron ore particles and an alkaline solution.

14. A system for electrolytically producing solid particles of an iron-bearing product from iron ore particles, said system comprising:
an electrochemical flow reactor provided with an electrochemical cell comprising a cathodic compartment and an anodic compartment separated by a separator, wherein the cathodic compartment houses a cathode at least partially in contact with an alkaline catholyte and the anodic compartment houses an anode at least partially in contact with an alkaline anolyte;
the alkaline catholyte comprising iron ore particles having a particle size P80 of greater than 20 μm suspended therein;
a voltage source configured to apply an electrical potential greater than 1.4V between the cathode and the anode in the electrochemical cell and electrolytically reduce the iron ore particles to solid particles of the iron-bearing product suspended in the alkaline solution thereby producing a spent catholyte;
a separation means in fluid communication with the cathodic compartment to separate the iron-bearing product particles from the spent catholyte and produce a depleted catholyte; and,
a means to introduce said iron ore particles into the depleted catholyte and thereby replenish said catholyte; wherein said means is in fluid communication with the cathodic compartment in an arrangement whereby replenished catholyte is re-circulated to the cathodic compartment.

15. The system according to claim 14, wherein the electrochemical cell comprises an assembly of alternating cathodic compartments and anodic compartments, wherein adjacent cathodic and anodic compartments are separated by respective separators.
